(19) United States
(12) Patent Application Publication
(10) Pub. No.: US 2019/0286925 A1
(43) Pub. Date: Sep. 19, 2019

(54) PARKING FRAME CONSTRUCTING DEVICE AND PARKING FRAME CONSTRUCTING METHOD

(71) Applicant: DENSO TEN Limited, Kobe-shi (JP)

(72) Inventor: Tetsuo YAMAMOTO, Kobe-shi (JP)

(73) Assignee: DENSO TEN Limited, Kobe-shi (JP)

(21) Appl. No.: 16/270,216

(22) Filed: Feb. 7, 2019

(30) Foreign Application Priority Data
Mar. 19, 2018 (JP) 2018-051180
Nov. 7, 2018 (JP) 2018-209880

(51) Int. Cl. G06K 9/00; G06T 7/70; G06K 9/62

(52) U.S. Cl. CPC G06K 9/00812; G06T 7/70; B62D 15/027; G06K 9/00798; G06T 2207/30264; G06K 9/6228

(57) ABSTRACT

A detector detects demarcation lines. A first grouper groups the detected demarcation lines into groups corresponding respectively to first predetermined areas. A first extractor extracts the demarcation line with the highest level of reliability from each of a first and a second group created by the first grouper. A second grouper extracts, from the detected demarcation lines, demarcation lines corresponding respectively to second predetermined areas each with respect to one of the demarcation lines extracted by the first extractor from the first and second groups respectively, and groups the extracted demarcation lines into a third and a fourth group respectively. A second extractor extracts, from the third group, the demarcation line closest to the fourth group and extracts, from the fourth group, the demarcation line closest to the third group. A constructor constructs a parking frame based on the demarcation lines extracted by the second extractor.

This nonprovisional application claims priority under 35 U.S.C. § 119(a) on Patent Application No. 2018-51180 filed in Japan on Mar. 19, 2018 and Patent Application No. 2018-209880 filed in Japan on Nov. 7, 2018, the entire contents of which are hereby incorporated by reference.

### BACKGROUND OF THE INVENTION

### 1. Field of the Invention

The present invention relates to a technology for constructing a parking frame based on detected demarcation lines (parking bay lines).

### 2. Description of Related Art

Recent years have seen development of a technology whereby demarcation lines such as white lines are detected from a camera image and, based on the detected demarcation lines, a parking frame is constructed (see, for example, Japanese Patent Application published as No. 2012-136206).

One inconvenience with the conventional parking frame constructing technology is that, for example, if demarcation lines are elongate U-shaped white lines as shown in FIG. 9, the outer lines OL may be detected as demarcation lines and then a parking frame may be constructed based on the outer lines OL. Another inconvenience is that, a pattern (for example, a letter, mark, stain, or the like) that can exist in or near a parking bay may be erroneously detected as a demarcation line and then a parking frame may be constructed based on the pattern.

### SUMMARY OF THE INVENTION

An object of the present invention is to provide a parking frame constructing technology with which a parking frame can be constructed with less deviation from an appropriate position.

According to one aspect of the present invention, a parking frame constructing device includes: a detector configured to detect demarcation lines from a taken image obtained by a camera taking an image around a vehicle; a first grouper configured to group the demarcation lines detected by the detector into groups corresponding respectively to first predetermined areas; a first extractor configured to extract a demarcation line with the highest level of reliability from each of a first and a second groups created by the first grouper; a second grouper configured to extract, from the demarcation lines detected by the detector, demarcation lines corresponding respectively to second predetermined areas each with respect to one of the demarcation lines extracted by the first extractor from the first and second groups respectively, and to group the extracted demarcation lines into a third and a fourth group respectively; a second extractor configured to extract, from the third group, the demarcation line closest to the fourth group and to extract, from the fourth group, the demarcation line closest to the third group; and a constructor configured to construct a parking frame based on the demarcation lines extracted by the second extractor.

According to another aspect of the present invention, a parking frame constructing method involves: a detecting step of detecting demarcation lines from a taken image obtained by a camera taking an image around a vehicle; a first grouping step of grouping the demarcation lines detected in the detecting step into groups corresponding respectively to first predetermined areas; a first extracting step of extracting a demarcation line with the highest level of reliability from each of a first and a second group created in the first grouping step; a second grouping step of extracting, from the demarcation lines detected in the detecting step, demarcation lines corresponding respectively to second predetermined areas each with respect to one of the demarcation lines extracted in the first extracting step from the first and second groups respectively, and grouping the extracted demarcation lines into a third and a fourth group respectively; a second extractive step of extracting, from the third group, the demarcation line closest to the fourth group and extracting, from the fourth group, the demarcation line closest to the third group; and a constructing step of constructing a parking frame based on the demarcation lines extracted in the second extracting step.

### BRIEF DESCRIPTION OF THE DRAWINGS

FIG. 1 is a diagram showing a configuration of a parking assist system according to one embodiment;

FIG. 2 is a flow chart showing an example of the operation of an image processing ECU and a parking control ECU;

FIG. 3 is a flow chart showing the details of a procedure for constructing a parking frame;

FIG. 4 is a top view showing one example of a plurality of demarcation lines detected by a detector;

FIG. 5 is a top view showing one example of demarcation lines grouped into a third and a fourth group;

FIG. 6 is a flow chart showing an algorithm for calculating a target parking position;

FIG. 7 is a top view showing a relationship between end point coordinates and candidate coordinates of a target parking position;

FIG. 8A is a top view showing another example of a plurality of demarcation lines detected by a detector;

FIG. 8B is a flow chart showing a modified example of a procedure for constructing a parking frame; and

FIG. 9 is a top view showing one example of demarcation lines.

### DETAILED DESCRIPTION OF PREFERRED EMBODIMENTS

Hereinafter, illustrative embodiments of the present invention will be described in detail with reference to the accompanying drawings. The different directions mentioned in the following description are defined as follows: The direction which runs along the vehicle's straight traveling direction and which points from the driver's seat to the steering wheel is referred to as the “front” direction (frontward). The direction which runs along the vehicle's straight traveling direction and which points from the steering wheel to the driver's seat is referred to as the “rear” direction (rearward). The direction which runs perpendicularly to both the vehicle's straight traveling direction and the vertical line and which points from the right side to the left side of the driver facing frontward is referred to as the “left” direction (leftward). The direction which runs perpendicularly to both the vehicle's straight traveling direction and the vertical line and which points from the left side to the right side of the driver facing frontward is referred to as the “right” direction (rightward). A vehicle furnished with a parking assist system is referred to as a “reference vehicle”.

1. Configuration of a Parking Assist System

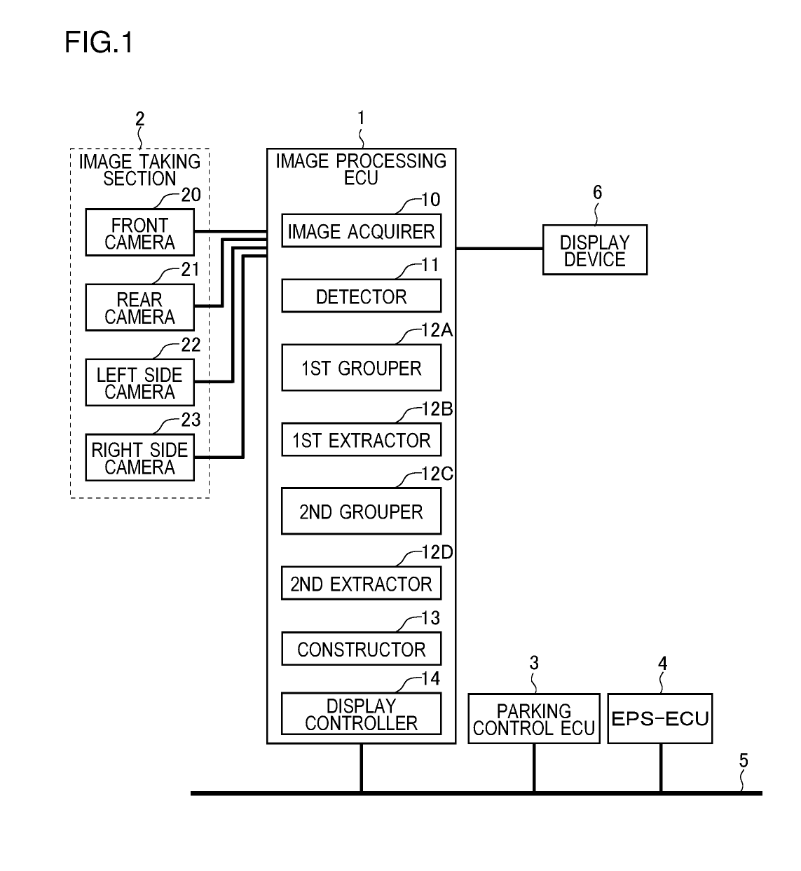

FIG. 1 is a diagram showing a configuration of a parking assist system according to one embodiment. The parking assist system shown in FIG. 1 includes an image processing ECU (electronic control unit) 1, an image taking section 2, a parking control ECU 3, an EPS (electronic power steering)-ECU 4, an on-board network 5, and a display device 6.

The image processing ECU 1 is connected to the image taking section 2 and to the display device 6, and is connected also to the parking control ECU 3 and to the EPS-ECU 4 via the on-board network 5 such as a CAN (controller area network).

The image taking section 2 includes four cameras 20 to 23. The camera 20 is provided at the front end of the reference vehicle. Accordingly, the camera 20 is referred to also as the front camera 20. The camera 21 is provided at the rear end of the reference vehicle. Accordingly, the camera 21 is referred to also as the rear camera 21. As seen in a top view, the optical axes of the front and back cameras 20 and 21 run along the front-rear direction of the reference vehicle. The front camera 20 takes an image frontward of the reference vehicle. The rear camera 21 takes an image rearward of the reference vehicle. The installation positions of the front and rear cameras 20 and 21 are preferably at the center in the left-right direction of the reference vehicle, but can instead be positions slightly deviated from the center in the left-right direction.

The camera 22 is provided on a left-side door mirror of the reference vehicle. Accordingly, the camera 22 is referred to also as the left side camera 22. In a case where the reference vehicle is what is called a door-mirrorless vehicle, the left side camera 22 is fitted somewhere around the pivot shaft (hinge) of the left side door with no door mirror in between. As seen in a top view, the optical axis of the left side camera 22 runs along the left-right direction of the reference vehicle. The left side camera 22 takes an image leftward of the reference vehicle. The camera 23 is provided on a right-side door mirror of the reference vehicle. Accordingly, the camera 23 is referred to also as the right side camera 23. In a case where the reference vehicle is what is called a door-mirrorless vehicle, the right side camera 23 is fitted somewhere around the pivot shaft (hinge) of the right side door with no door mirror in between. As seen in a top view, the optical axis of the right side camera 23 runs along the left-right direction of the reference vehicle. The right side camera 23 takes an image rightward of the reference vehicle.

The image processing ECU 1 includes an image acquirer 10, a detector 11, a first grouper 12A, a first extractor 12B, a second grouper 12C, a second extractor 12D, a constructor 13, and a display controller 14. The image processing ECU 1 acts both as a parking frame constructing device that constructs a parking frame and as a display control device that controls display on the display device 6.

The image processing ECU 1 can be composed of, for example, a controller and a storage. The controller is a computer including a CPU (central processing unit), a RAM (random-access memory), and a ROM (read-only memory). The storage stores, on a non-volatile basis, computer programs and data necessary for the image processing ECU 1 to operate to function as the image acquirer 10, the detector 11, the first grouper 12A, the first extractor 12B, the second grouper 12C, the second extractor 12D, the constructor 13, and the display controller 14. Usable as the storage is, for example, an EEPROM or a flash memory.

The image acquirer 10 acquires an analog or digital taken image from each of the cameras 20 to 23 at a predetermined period (for example, at a period of 1/30 seconds) in a temporally continuous fashion. In a case where the acquired temporally continuous taken image (acquired image) is analog, the image acquirer 10 converts the analog taken image into a digital taken image (through analog-to-digital conversion).

The detector 11 detects, from the image taken by the cameras 20 to 23 and output from the image acquirer 10, demarcation lines (bay lines) through image processing such as edge extraction at a period of, for example, 100 ms. Demarcation lines are drawn, in the form of white lines, on the ground surface of a parking facility. The detector 11, however, is configured, through image processing such as shape recognition, not to detect, as demarcation lines, curved parts of white lines and the like drawn on the ground surface of a parking facility.

The first grouper 12A groups the demarcation lines detected by the detector 11 into groups corresponding respectively to first predetermined areas.

From each of a first group and a second group created by the first grouper 12A, the first extractor 12B extracts the demarcation line with the highest level of reliability. The level of liability of a demarcation line can be determined based on the taken image obtained by the cameras 20 to 23, and can be calculated from the length of an edge, the density of the feature points constituting the edge, and the like. In this embodiment, the first extractor 12B classifies each demarcation line in each of the first and second groups into one of five classes according how high its level of reliability is. Reliability, which will be dealt with later, is related to “level of reliability”. As a criterion for determining whether reliability is high or not, it is possible to use a “level of reliability” itself. As a criterion for determining whether reliability is high or not, it is possible to use, instead, any of the elements used to calculate a level of reliability (for example, the length of an edge and the like mentioned above). As a criterion for determining whether reliability is high or not, it is possible even to use any of the features of a demarcation line that is not used in calculating a level of reliability but that is regarded as correlating to a level of reliability.

Out of the demarcation lines detected by the detector 11, the second grouper 12C extracts demarcation lines corresponding respectively to second predetermined areas each with respect to one of the demarcation lines extracted by the first extractor 12B from the first and second groups respectively, and groups the extracted demarcation lines into a third group and a fourth group respectively.

The second extractor 12D extracts, from the third group, the demarcation line closest to the fourth group, and extracts, from the fourth group, the demarcation line closest to the third group.

The constructor 13 constructs a parking frame based on the demarcation lines extracted by the second extractor 12D.

The image processing ECU 1 calculates a target parking position corresponding to the parking frame constructed by the constructor 13. The image processing ECU 1 then transmits the target parking position to the parking control ECU 3, and then receives a target parking position inferred by the parking control ECU 3.

The display controller 14 controls display on the display device 6. For example, the display controller 14 generates a display image having an indicator indicating the target parking position overlaid on the taken image output from the image acquirer 10.

The parking control ECU 3 infers, based on the target parking position received from the image processing ECU 1 and the output of an unillustrated clearance sonar sensor, a parkable target parking position. The parking control ECU 3 may instead first infer the amount of movement of the reference vehicle based on information on the reference vehicle's steering angle, traveling speed, shift position, and the like acquired via the on-board network 5 and then infer, based on the inferred amount of movement of the reference vehicle and the target parking position received from the image processing ECU 1, a target parking position corresponding to the inferred amount of movement of the reference vehicle. The parking control ECU 3 transmits the inferred target parking position to the image processing ECU 1. Furthermore, the parking control ECU 3 calculates, based on the output of the unillustrated clearance sonar sensor and the target parking position, an amount of steering, and transmits information on the amount of steering to the EPS-ECU 4. Any target parking position that cannot be attained by any steering control is deleted during the estimation of a target parking position.

Based on the information on the amount of steering received from the parking control ECU 3, the EPS-ECU 4 performs automatic steering during parking operation of the reference vehicle. On the other hand, accelerating and braking are performed by the driver.

2. Operation of the Image Processing ECU and the Parking Control ECU

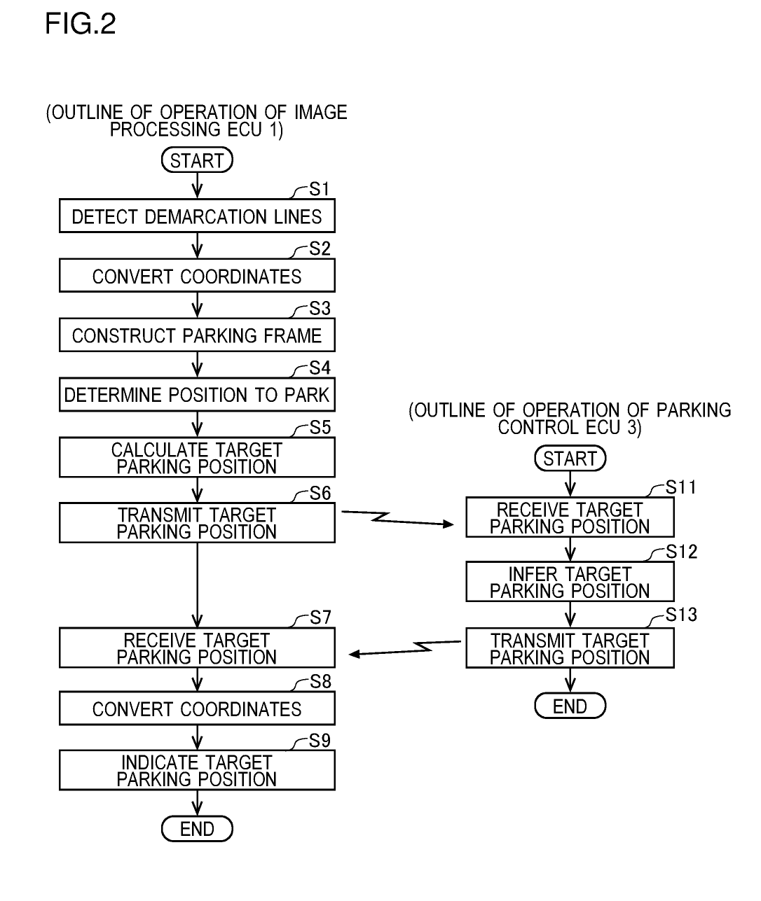

Next, the operation of the image processing ECU 1 and the parking control ECU 3 will be described. FIG. 2 is a flow chart showing an example of the operation of the image processing ECU 1 and the parking control ECU 3.

In the flow of operation shown in FIG. 2, first, the detector 11 tries to detect demarcation lines (step S1).

Having detected demarcation lines, the detector 11 converts the coordinate system of the camera image into a coordinate system (world coordinate system) with its origin located at a particular point on the vehicle (step S2). In this embodiment, the particular point on the vehicle is defined to be a point that is apart rearward from the front end of the vehicle by an effective length (the length calculated by subtracting the rear overhang from the vehicle's total length) and that is at the middle in the left-right direction of the vehicle. In the world coordinate system, the front-rear direction of the vehicle is the Z-axis direction (the rear direction being the positive Z-axis direction), and the left-right direction of the vehicle is the X-axis direction (the left direction being the positive X-axis direction).

Subsequently to step S2, at step S3, the constructor 13 constructs a parking frame. The procedure for constructing a parking frame will be described in detail later.

Next, based on the parking frame constructed by the constructor 13, the image processing ECU 1 determines a parking position at which to park (step S4). Next, the image processing ECU 1 calculates a target parking position corresponding to the determined parking position (step S5), and transmits information on the target parking position to the parking control ECU 3 (step S6).

The parking control ECU 3 receives the information on the target parking position from the image processing ECU 1 (step S11). Next, based on the received information on the target parking position and the output of the clearance sonar sensor, the parking control ECU 3 infers a target parking position (step S12). The parking control ECU 3 may instead infer, based on the received information on the target parking position, a target parking position corresponding to the amount of movement of the reference vehicle. Then, the parking control ECU 3 transmits information on the inferred target parking position to the image processing ECU 1 (step S13).

The image processing ECU 1 receives the information on the target parking position inferred by the parking control ECU 3 (step S7). The image processing ECU 1 recognizes, instead of the already calculated target parking position (step S5), the target parking position inferred by the parking control ECU 3 as a new target parking position. Next, the image processing ECU 1 converts the world coordinate system back to the coordinate system of the camera image (step S8). Then, based on the target parking position newly recognized by the image processing ECU 1, the display controller 14 generates a display image having an indicator indicating the target parking position overlaid on the taken image output from the image acquirer 10, and shows the target parking position on the display screen of the display device 6 (step S9).

The image processing ECU 1 constantly checks for a terminating event during the flow of operation shown in FIG. 2 so that, when a terminating event occurs, the image processing ECU 1 immediately terminates the flow of operation shown in FIG. 2. Examples of terminating events include, for example, the distance from the coordinates of the target parking position to the origin in the world coordinate system having become equal to or less than a predetermined value which approximately equals zero, and the traveling speed of the reference vehicle having become higher than a predetermined speed.

3. Details of Processing for Parking Frame Construction

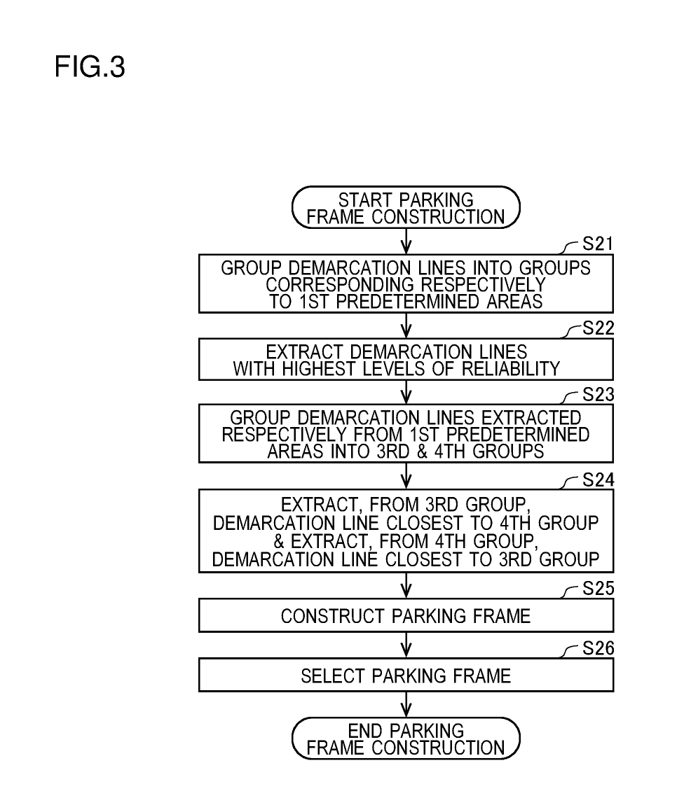

Next, the procedure for constructing a parking frame will be described in detail. FIG. 3 is a flow chart showing the procedure for parking frame construction.

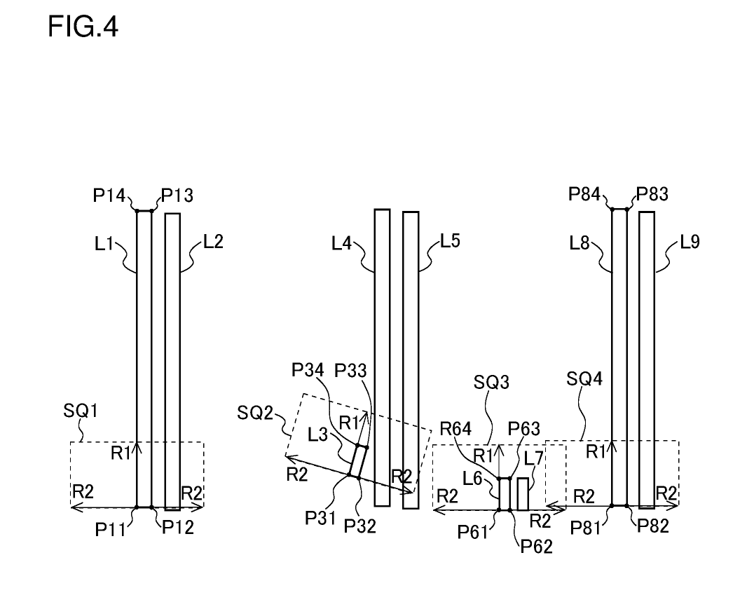

The first grouper 12A groups the demarcation lines detected by the detector 11 into groups corresponding respectively to first predetermined areas (step S21). An example of how first predetermined areas are set will now be described, taking a case where the detector 11 has detected demarcation lines L1 to L9 as shown in FIG. 4.

With respect to an end point P11, which is one of the two end points P11 and P12 closer to the reference vehicle among the four end points P11 to P14 of a given demarcation line L1, a distance R1 is taken along the long-side direction of the demarcation line L1 and a distance R2 is taken along the short-side direction of the demarcation line L1 on either side of it to determine a square SQL The demarcation lines L1 and L2 that overlap the square SQ1 are grouped into one group. The distances R1 and R2 may be equal to, or different from, each other.

The other demarcation lines L3 to L9 are grouped in similar manners. For example, with respect to an end point P31, which is one of the two end points P31 and P32 closer to the reference vehicle among the four end points P31 to P34 of another given demarcation line L3, a distance R1 is taken along the long-side direction of the demarcation line L3 and a distance R2 is taken along the short-side direction of the demarcation line L3 on either side of it to determine a square SQ2. The demarcation lines L3 to L5 that overlap the square SQ2 are grouped into one group. For another example, with respect to an end point P61, which is one of the two end points P61 and P62 closer to the reference vehicle among the four end points P61 to P64 of yet another given demarcation line L6, a distance R1 is taken along the long-side direction of the demarcation line L6 and a distance R2 is taken along the short-side direction of the demarcation line L6 on either side of it to determine a square SQ3. The demarcation lines L6 and L7 that overlap the square SQ3 are grouped into one group. For another example, with respect to an end point P81, which is one of the two end points P81 and P82 closer to the reference vehicle among the four end points P81 to P84 of still another given demarcation line L8, a distance R1 is taken along the long-side direction of the demarcation line L8 and a distance R2 is taken along the short-side direction of the demarcation line L8 on either side of it to determine a square SQ4. The demarcation lines L8 and L9 that overlap the square SQ4 are grouped into one group. In the just-described example of how first predetermined areas are set, the squares SQ1 to SQ4 are each a first predetermined area.

Subsequent to step S21, at step S22, from each of a first group and a second group created by the first grouper 12A, the first extractor 12B extracts the demarcation line with the highest level of reliability. As the first and second groups, the first extractor 12B selects, for example, a pair of groups in a predetermined positional relationship (for example, apart from each other by a distance approximately equal to the vehicle width). The first extractor 12B can select, for example, a pair of groups between which the first predetermined areas are apart from each other by a distance equal to or more than a first threshold value TH1 but equal to or less than a second threshold value TH2. In terms of the example shown in FIG. 4, the first and second threshold values TH1 and TH2 can be set such that the group to which the demarcation lines L1 and L2 belong and the group to which the demarcation lines L3 to L5 belong are taken as one pair of first and second groups, and the group to which the demarcation lines L3 to L5 belong and the group to which the demarcation lines L8 and L9 belong are taken as another pair of first and second groups.

A case will now be discussed where the group to which the demarcation lines L1 and L2 belong is taken as the first group and the group to which the demarcation lines L3 to L5 belong is taken as the second group. The following description deals with an example where the demarcation line with the highest level of reliability in the first group is the demarcation line L2 and the demarcation line with the highest level of reliability in the second group is the demarcation line L5.

Subsequently to step S22, at step S23, out of the demarcation lines detected by the detector 11, the second grouper 12C extracts demarcation lines corresponding to a second predetermined area with respect to the demarcation line L2 with the highest level of reliability in the first group, and groups the extracted demarcation lines into a third group. Likewise, out of the demarcation lines detected by the detector 11, the second grouper 12C extracts demarcation lines corresponding to a second predetermined area with respect to the demarcation line L5 with the highest level of reliability in the second group, and groups the extracted demarcation lines into a fourth group.

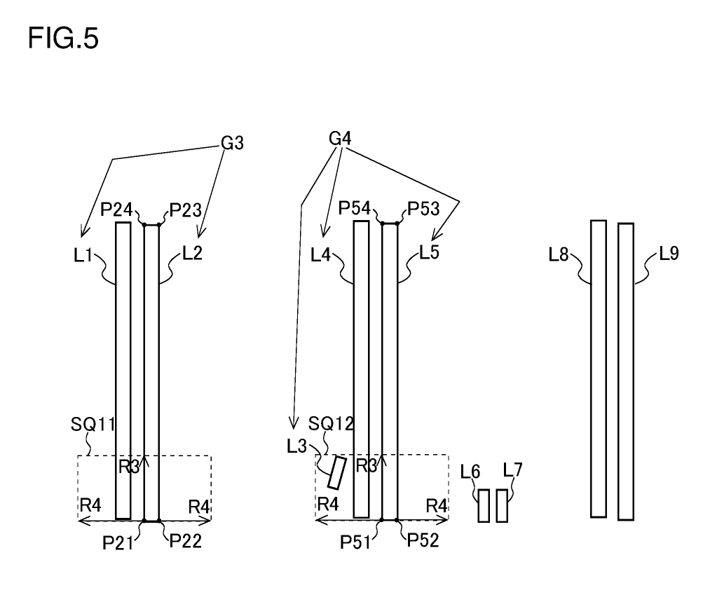

For example, as shown in FIG. 5, with respect to an end point P21, which is one of the two end points P21 and P22 closer to the reference vehicle among the four end points P21 to P24 of the demarcation line L2, a distance R3 is taken in the long-side direction of the demarcation line L2, and a distance R4 is taken along the short-side direction of the demarcation line L2 on either side of it to define a square SQ11. The demarcation lines L1 and L2 that overlap the square SQ11 are extracted and grouped into the third group G3. Likewise, with respect to an end point P51, which is one of the two end points P51 and P52 closer to the reference vehicle among the four end points P51 to P54 of the demarcation line L5, a distance R3 is taken in the long-side direction of the demarcation line L5, and a distance R4 is taken along the short-side direction of the demarcation line L5 on either side of it to define a square SQ12. The demarcation lines L3 to L5 that overlap the square SQ12 are extracted and grouped into the fourth group G4. The distances R3 and R4 may be equal to, or different from, each other. The distances R3 and R1 may be equal to, or different from, each other. The distances R4 and R2 may be equal to, or different from, each other.

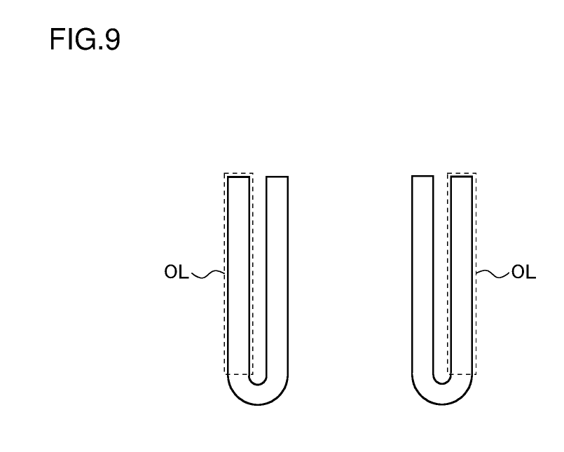

Subsequently to step S23, at step S24, the second extractor 12D extracts, from the third group G3, the demarcation line L2 closest to the fourth group G4, and extracts, from the fourth group G4, the demarcation line L3 closest to the third group G3. In this way, the innermost demarcation lines are extracted, and this reduces the likelihood of, for example, the outside lines OL shown in FIG. 9 being detected as demarcation lines and a parking frame being constructed based on the outside lines OL.

Subsequently to step S24, at step S25, the constructor 13 constructs a parking frame based on the demarcation lines extracted by the second extractor 12D. In a case where a plurality of pairs of first and second groups are created, a plurality of parking frames are constructed.

Subsequently to step S25, at step S26, the image processing ECU 1 selects a parking frame constructed at step S25 based on its shape, level of reliability, positional relationship with the reference vehicle, and the like.

Based on the parking frame selected by the constructor 13 at step S26, the image processing ECU 1 calculates a target parking position. When the selection of the parking frame at step S26 is complete, the procedure for parking frame construction ends.

In the above description, a demarcation line L3 that is considered to be a pattern (for example, a letter, mark, stain, or the like) that can exist in or near a parking bay is extracted by the second extractor 12D. To prevent such erroneous detection, it is preferable to perform, at step S23, a process as will be described below for extracting demarcation lines with high reliability. That is, it is preferable that the second grouper 12C discriminate demarcation lines with high reliability from those with low reliability and extract demarcation lines with high reliability.

At step S23, it is preferable that the second grouper 12C extract only demarcation lines with levels of reliability equal to or higher than a predetermined level as demarcation lines with high reliability. For example, the second grouper 12C can take, as demarcation lines with levels of reliability equal to or higher than a predetermined level, the demarcation lines that belong to the two ranks immediately under the rank to which the demarcation line with the highest level of reliability extracted by the first extractor 12B belongs. This helps reduce the likelihood of a pattern (for example, a letter, mark, stain, or the like) that can exist in or near a parking bay being erroneously detected as a demarcation line.

At step S23, it is preferable that, instead of, or in addition to, extracting only demarcation lines with levels of reliability equal to or higher than a predetermined level, the second grouper 12C extract only demarcation lines with lengths equal to or larger than a threshold value as demarcation line with high reliability. A pattern (for example, a letter, mark, stain, or the like) that can exist in or near a parking bay is generally shorter than a demarcation line, and the just-described process helps reduce the likelihood of a pattern (for example, a letter, mark, stain, or the like) that can exist in or near a parking bay being erroneously detected as a demarcation line.

Moreover, instead of, or in addition to, at least one of extracting only demarcation lines with levels of reliability equal to or higher than a predetermined level and extracting only demarcation lines with lengths equal to or larger than a threshold value, the second grouper 12C may extract only demarcation lines of which the angles relative to the demarcation lines extracted by the first extractor 12B are within a predetermined range of angles as demarcation lines with high reliability. A pair of demarcation lines indicating a parking bay is generally parallel, and accordingly the predetermined range of angles can be, for example, a range around zero degrees. Two demarcation lines generally do not intersect; thus, the angle can be calculated as the angle of intersection between an imaginary line assumed by translating one demarcation line parallel and the other demarcation line. A pattern (for example, a letter, mark, stain, or the like) that can exist in or near a parking bay is generally not parallel to a demarcation line, and thus the just-described process helps reduce the likelihood of a pattern (for example, a letter, mark, stain, or the like) that can exist in or near a parking bay being erroneously detected as a demarcation line.

Through a process as described above performed at step S23, in the example shown in FIG. 5, the demarcation line L3 with low reliability is eliminated from the fourth group G4, so that the demarcation lines L4 and L5 with high reliability are extracted. Thus, the second extractor 12D extracts, from the third group G3, the demarcation line L2 closest to the fourth group G4, and extracts, from the fourth group G4, the demarcation line L4 closest to the third group G3. As a result, at step S25, the constructor 13 constructs a parking frame based on the demarcation lines L2 and L4 extracted by the second extractor 12D, and can thus construct an accurate parking frame.

4. Calculating a Target Parking Position

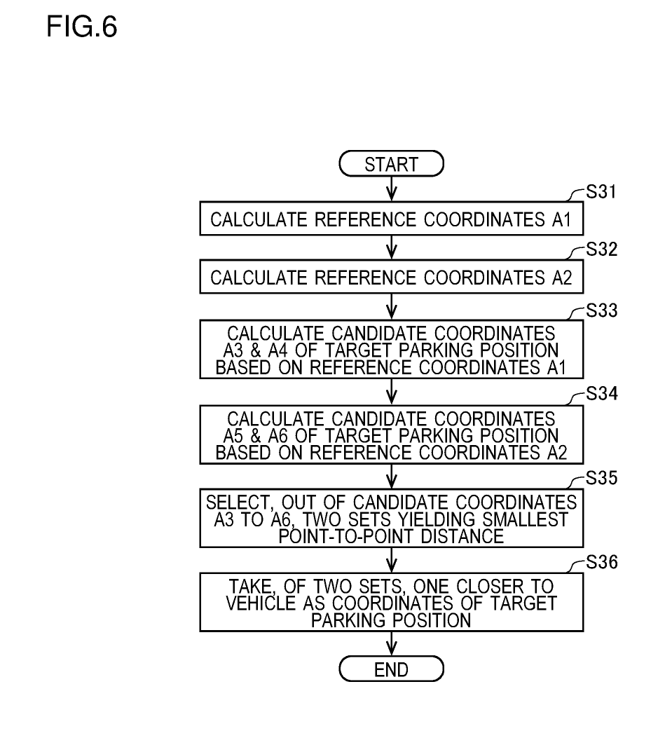

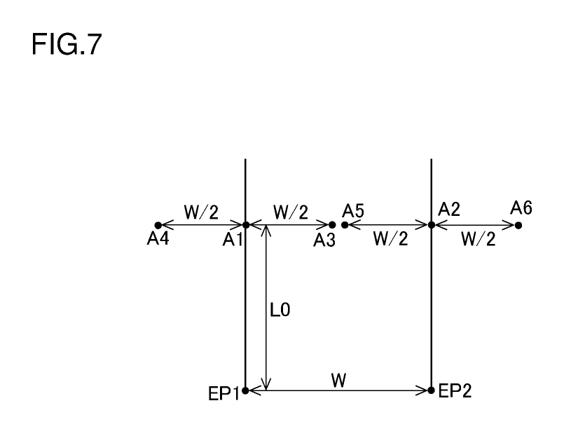

Next, how the image processing ECU 1 calculates a target parking position will be described. FIG. 6 is a flow chart showing the algorithm for calculating a target parking position. FIG. 7 is a top view showing a relationship between end point coordinates and candidate coordinates of a target parking position.

In calculating a target parking position, first, the image processing ECU 1 calculates first coordinates A1 apart from end point coordinates EP1 of one demarcation line in the direction opposite from the vehicle by the effective length L0 (the length calculated by subtracting the rear overhang from the vehicle's total length) (step S31). Next, the image processing ECU 1 calculates second coordinates A2 apart from end point coordinates EP2 of the other demarcation line in the direction opposite from the vehicle by the effective length L0 (step S32). The results of parking frame construction include information on the end point coordinates EP1 and EP2 of the demarcation lines.

Next, the image processing ECU 1 calculates third coordinates A3 apart from the first coordinates A1 in the direction perpendicular to the long-side direction of the one demarcation line toward the other demarcation line by half the distance W between the end point coordinates EP1 and the other demarcation line, and calculates fourth coordinates A4 apart from the first coordinates A1 in the direction perpendicular to the long-side direction of the one demarcation line away from the other demarcation line by half the distance W (step S33). Moreover, the image processing ECU 1 calculates fifth coordinates A5 apart from the second coordinates A2 in the direction perpendicular to the long-side direction of the other demarcation line toward the one demarcation line by half the distance W, and calculates sixth coordinates A6 apart from the second coordinates A2 in the direction perpendicular to the long-side direction of the other demarcation line away from the one demarcation line by half the distance W (step S34).

Out of the third to sixth coordinates A3 to A6, the image processing ECU 1 selects two sets of coordinates that yield the smallest point-to-point distance (step S35), and takes, out of the two sets of coordinates selected, the one closer to the vehicle (the one with the shorter distance to the origin) as the coordinates of the target parking position (step S36), thereby ending the algorithm for calculating the coordinates of a target parking position.

Through the flow of operation shown in FIG. 6, the coordinates of a target parking position can be set at the position that is inward of the vehicle-side ends (the entrance of a parking bay) of the two demarcation lines by the effective length L0 and that is located at the middle between the two demarcation lines.

5. Notes

The various technical features disclosed herein may be implemented in any other manner than as in the embodiment described above, and allow for many modifications without departing from the spirit of the present invention. That is, the embodiment descried above should be understood to be in every aspect illustrative and not restrictive. The technical scope of the present invention is defined not by the description of the embodiment given above but by the appended claims, and should be understood to encompass any modifications made in the sense and scope equivalent to those of the claims.

For example, although the embodiment described above deals with a configuration where a single ECU (image processing ECU) is provided with a parking frame constructing device and a display control device, a parking frame constructing device and a display control device may instead be implemented in separate ECUs.

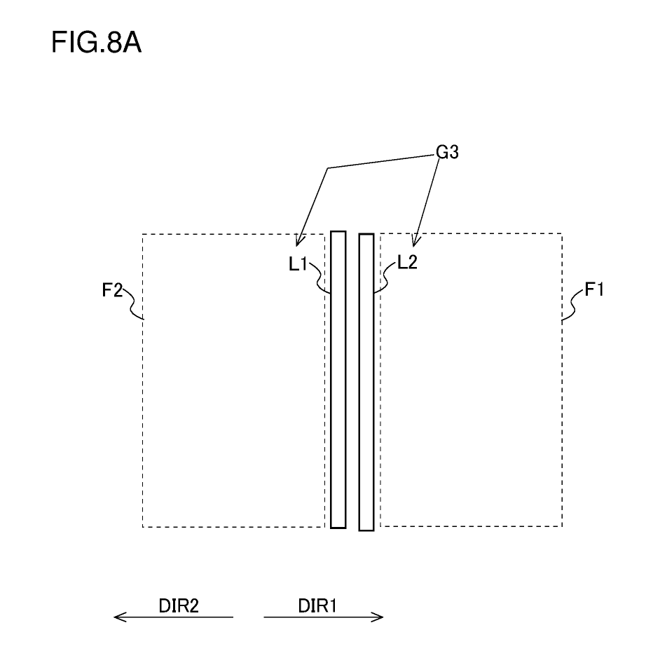

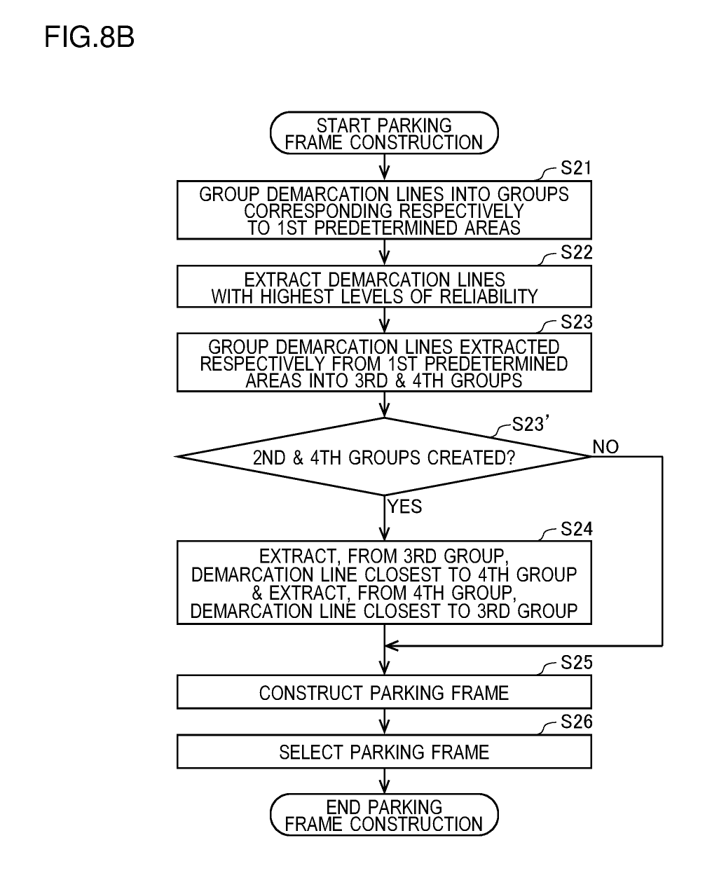

For example, when the detector 11 detects only demarcation lines L1 and L2 as shown in FIG. 8A, the first grouper 12A can create only a first group, and cannot create a second group. To cope with such a situation, instead of the flow of operation shown in FIG. 3, the flow of operation shown in FIG. 8B may be executed so that, even when the first grouper 12A cannot create a second group and thus the second grouper 12C cannot create a fourth group, if only a first group is created, a parking frame is constructed.

Compared with the flow of operation shown in FIG. 3, the flow of operation shown in FIG. 8B additionally has step S23′. Subsequently to step S23, at step S23′, the image processing ECU 1 checks whether a second group and a fourth group have been created. If a second group and a fourth group have not been created, a jump is made to step S25 without going through step S24. In this case, based on the demarcation line located farthest in a first direction among those belonging to the third group, the constructor 13 constructs a parking frame located in the first direction relative to the third group.

For example, if the first direction is the direction DIR1 in FIG. 8A, then, based on the demarcation line L2, the constructor 13 constructs a parking frame F1 located in the direction DIR1 relative to the third group G3. For another example, if the first direction is the direction DIR2 in FIG. 8A, then, based on the demarcation line L1, the constructor 13 constructs a parking frame F2 located in the direction DIR2 relative to the third group G3. Even both of the directions DIR1 and DIR2 in FIG. 8A may be taken as the first direction, in which case the constructor 13 constructs parking frames F1 and F2 simultaneously.

What is claimed is:

1. A parking frame constructing device comprising:
a detector configured to detect demarcation lines from a taken image obtained by a camera taking an image around a vehicle;
a first grouper configured to group the demarcation lines detected by the detector into groups corresponding respectively to first predetermined areas;
a first extractor configured to extract a demarcation line with a highest level of reliability from each of a first group and a second group created by the first grouper;
a second grouper configured to extract, from the demarcation lines detected by the detector, demarcation lines corresponding respectively to second predetermined areas each with respect to one of the demarcation lines extracted by the first extractor from the first and second groups respectively, and to group the extracted demarcation lines into a third group and a fourth group respectively;
a second extractor configured to extract, from the third group, a demarcation line closest to the fourth group and to extract, from the fourth group, a demarcation line closest to the third group; and
a constructor configured to construct a parking frame based on the demarcation lines extracted by the second extractor.

2. The parking frame constructing device according to claim 1, wherein
the second grouper extracts demarcation lines with high reliability related to the level of reliability.

3. The parking frame constructing device according to claim 2, wherein
the second grouper extracts demarcation lines with levels of reliability equal to or higher than a predetermined level as the demarcation lines with high reliability.

4. The parking frame constructing device according to claim 2, wherein
the second grouper extracts demarcation lines with lengths equal to or larger than a threshold value as the demarcation lines with high reliability.

5. The parking frame constructing device according to claim 2, wherein
the second grouper extracts demarcation lines of which angles relative to a demarcation line extracted by the first extractor is in a predetermined range of angles as the demarcation lines with high reliability.

6. The parking frame constructing device according to claim 1, wherein
when the first grouper cannot create the second group, the constructor constructs, based on a demarcation line located farthest in a first direction in the third group, a parking frame located in the first direction relative to the third group.

7. A parking frame constructing method comprising:
a detecting step of detecting demarcation lines from a taken image obtained by a camera taking an image around a vehicle;
a first grouping step of grouping the demarcation lines detected in the detecting step into groups corresponding respectively to first predetermined areas;
a first extracting step of extracting a demarcation line with a highest level of reliability from each of a first group and a second group created in the first grouping step;
a second grouping step of extracting, from the demarcation lines detected in the detecting step, demarcation lines corresponding respectively to second predetermined areas each with respect to one of the demarcation lines extracted in the first extracting step from the first and second groups respectively, and grouping the extracted demarcation lines into a third group and a fourth group respectively;
a second extractive step of extracting, from the third group, a demarcation line closest to the fourth group and extracting, from the fourth group, a demarcation line closest to the third group; and
a constructing step of constructing a parking frame based on the demarcation lines extracted in the second extracting step.
